(19) United States
(12) Patent Application Publication
(10) Pub. No.: US 2017/0262546 A1
(43) Pub. Date: Sep. 14, 2017

(54) KEY SEARCH TOKEN FOR ENCRYPTED DATA

(71) Applicant: HEWLETT PACKARD ENTERPRISE DEVELOPMENT LP, Houston, TX (US)

(72) Inventors: Liqun Chen, Bristol (GB); Stuart Haber Haber, Princeton, NJ (US); Kate Mallichan, Bristol (GB); Simon Kai-Ying Shiu, Bristol (GB)

(21) Appl. No.: 15/500,028

(22) PCT Filed: Jul. 30, 2014
(86) PCT No.: PCT/US2014/048872

§ 371 Date: Jan. 28, 2017

(51) Int. Cl. G06F 17/30; H04L 29/06; H04L 9/08

(52) U.S. Cl. CPC G06F 17/30867; H04L 9/0861; H04L 63/0428

(57) ABSTRACT

Implementations are directed, for example, to a method that includes receiving, at a data storage system from a client, a key search token that has not been used to encrypt data records or keywords associated with the data records. The key search token is independent of an encryption key used to encrypt the data records associated with the key search token. The method further includes determining an encrypted data record associated with the key search token, and transmitting the determined encrypted data record to the client. Implementations of the client are also provided.

### BACKGROUND

Data storage systems store data on behalf of one or more users of such data. The data may or may not be stored in encrypted form. The users may submit a search request to the data storage system to search for particular data of interest. The data storage system performs the search and transmits the requested data to the user.

### BRIEF DESCRIPTION OF THE DRAWINGS

For a detailed description of various examples, reference will now be made to the accompanying drawings in which:

FIG. 1 shows a system in accordance with various examples;

FIG. 2 shows another system including a key manager in accordance with various examples;

FIG. 3 illustrates a data structure in accordance with various examples;

FIG. 4 shows a method in accordance with various examples;

FIG. 5 shows a method for generating child keys in accordance with various examples;

FIG. 6 illustrates the relationship between a parent encryption key and child encryption keys in accordance with various examples; and

FIG. 7 shows an illustrative block diagram of a client in accordance with various examples.

### DETAILED DESCRIPTION

Users may store data stored in encrypted form (called “encrypted data”) in a storage device. Such users may desire for their encrypted data to be searchable, and to be searchable without requiring the data first to be decrypted in order for user-based searches of the encrypted data to be performed. That is, when a user desires to perform a search of certain data items, it would be desirable for the encrypted data to be searchable while still in its encrypted form. For some applications, different data items may be associated with a particular encryption key that was used to encrypt such data items. Further, different sets of data items may be encrypted with different encryption keys. The association of the various encryption keys to the encrypted data sets that each such key was used to encrypt should be protected. The examples disclosed herein provide searchable encryption techniques while authorizing users' desires to use the proper encryption key for their own encrypted data.

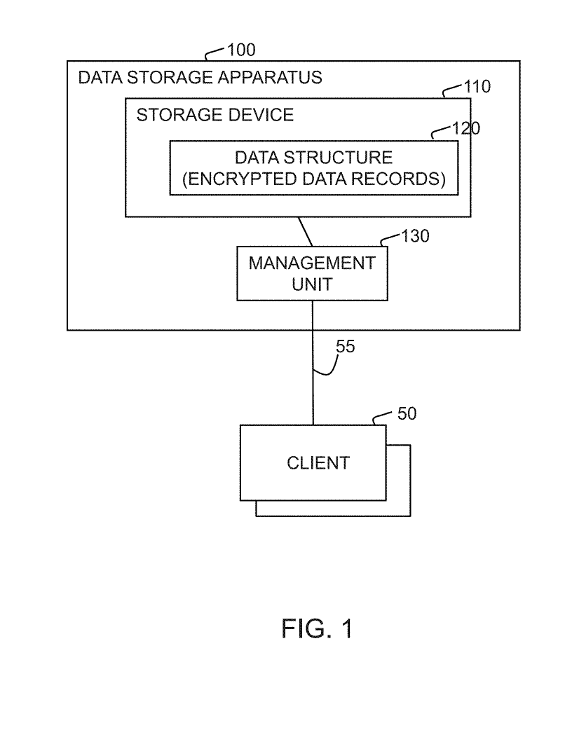

FIG. 1 shows a system including a data storage system 100 accessible by one or more clients 50. Any number of clients may access the data storage system. Each client 50 represents a computing apparatus such as a computer (desktop, notebook, tablet device, etc.). The connection 55 between each client 50 and the data storage system 100 may be wired and/or wireless and may include, for example, the Internet.

The data storage system 100 includes a storage device 110 coupled to a management unit 130. The storage device 110 includes non-transitory storage such as non-volatile storage (magnetic storage, optical storage, solid state storage, etc.), volatile storage (e.g., random access memory), or combinations thereof. Each client 50 may encrypt data and submit such encrypted data to the data storage system for storage in the storage device 110. Data is encrypted based on an encryption key and each client 50 may use a different encryption key to encrypt the data for each such client. Further, a given client 50 may use multiple different encryption keys to encrypt different sets of data. The storage device 110 stores encrypted data on behalf of multiple clients 50 and such encrypted data may include sets of data encrypted with different encryption keys. The encrypted data is stored in a data structure 120 contained in storage device 110.

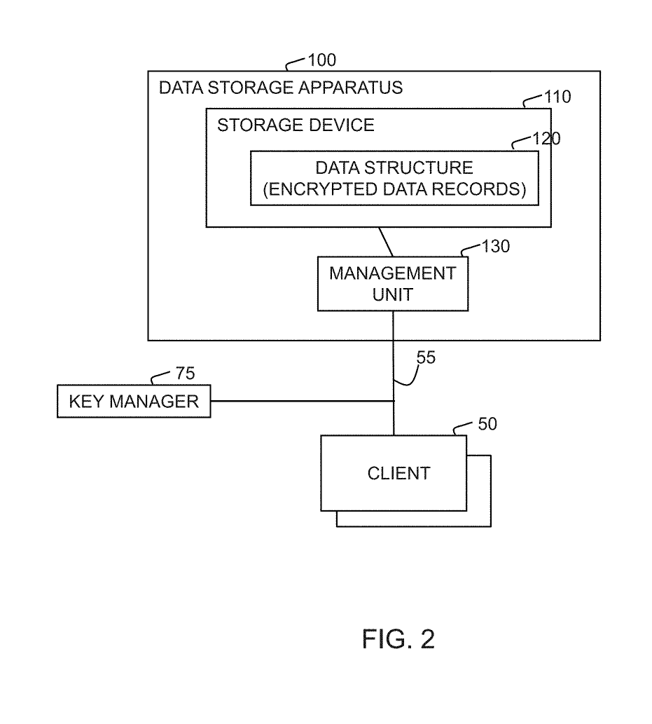

In the example of FIG. 1, each client 50 may generate its own encryption keys for use in encrypting its data. FIG. 2 shows an example similar to that of FIG. 1 with the difference being the inclusion of a key manager 75. The key manager 75 may generate the encryption keys itself and provide them to the client 50 as needed by the client. Also or alternatively, the key manager may store and manage the keys that are generated by the client 50 or another entity. Each client 50 may submit a request for a key to the key manager 75, which may respond with a key. Thus, each client 50 causes encryption keys to be generated, either by generating the keys itself (FIG. 1) or by obtaining and using keys generated by key manager 75 (FIG. 2).

In accordance with the disclosed examples, each client 50 is able to perform a search for encrypted data stored on the data storage system using any of a plurality of search tokens. The search tokens may include any or all of:
A plaintext keyword
An encrypted version of a plaintext keyword (an “encrypted keyword”)
A key search token.

The plaintext keyword may be, for example, any string of alphanumeric characters desired by a user to be associated with a particular encrypted data record. The plaintext keyword may be a string of alphanumeric characters that is contained in the plaintext version of the encrypted data record, but the plaintext keyword need not be present in the plaintext version of the encrypted data record.

The encrypted keyword is, as the name suggests, an encrypted version of an otherwise plaintext keyword. Any suitable encryption algorithm can be employed to actually encrypt a plaintext keyword to produce a corresponding encrypted keyword. For example, a technique may be used that can produce a cryptographically unpredictable value that is computed based on the plaintext keyword.

The key search token is a string of symbols (e.g., bits) having high entropy which means that its prediction is computationally infeasible. A prediction task is “computationally infeasible” if the probability of success is less than a threshold. The key search token is not an encryption key in that it is not used to actually encrypt a data record or a keyword. The key search token is chosen independent of the encryption key that is used to encrypt the data record associated with the key search token meaning that the key search token is not mathematically derived from the encryption key. In some implementations, the key search token is determined based on a random number generator.

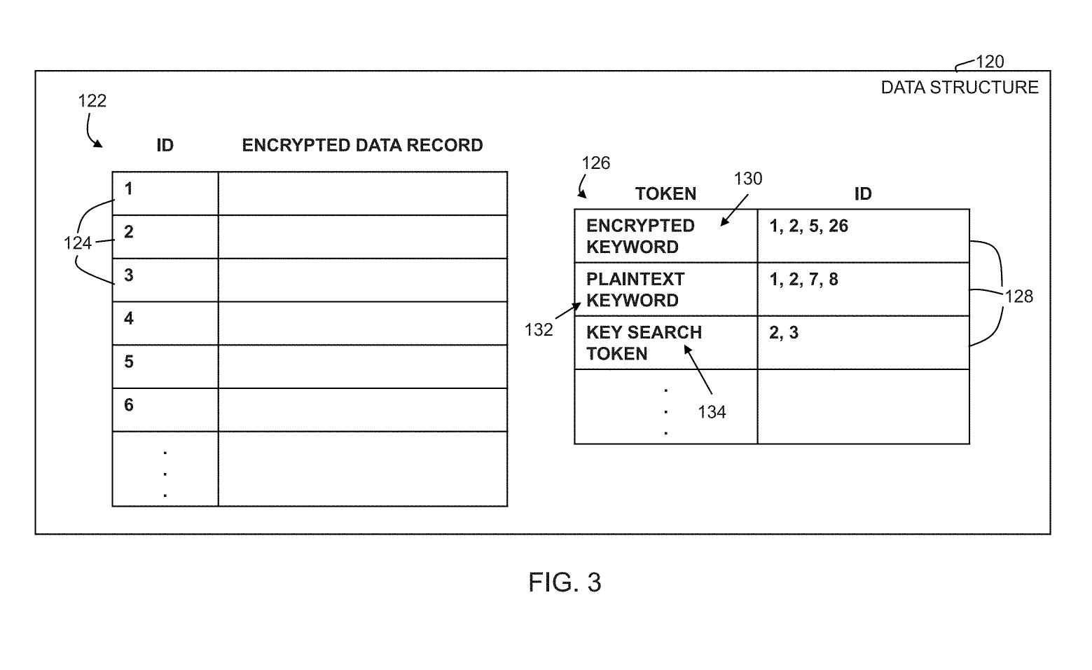

FIG. 3 illustrates an example of the data structure 120 of FIGS. 1 and 2. The illustrative data structure 120 includes a plurality of tables 122 and 126. Table 122 includes a plurality of entries 124. Each entry 124 includes an encrypted data record and a corresponding identifier (ID) to uniquely identify each such data record. Table 126 also includes a plurality of entries 128 Each entry 128 in table 126 includes a token usable to perform a search of the encrypted data records and one or more associated IDs which correspond to the IDs of table 122. The tokens may include any or all of: encrypted keywords, plaintext keywords and key search tokens. Token 130 in table 126 is an encrypted keyword and is associated with IDs 1, 2, 5, and 26. This means that token 130 is associated with the encrypted data records in table 122 that are themselves associated with IDs 1, 2, 5, and 26. As such, when a client 50 submits this encrypted keyword token 130, the management unit 130 of the data storage system consults the tables 122 and 126 and determines that the encrypted data records to be provided back to the client based on that particular encrypted keyword search token are the encrypted data records having IDs 1, 2, 5, and 26.

Similarly, token 132 in table 126 is a plaintext keyword and is associated with IDs 1, 2, 7, and 8, which means that token 132 is associated with the encrypted data records in table 122 that are themselves associated with IDs 1, 2,7, and 8. Token 134 in table 126 is a key search token and is associated with IDs 2 and 3, which means that token 136 is associated with the encrypted data records in table 122 that are themselves associated with IDs 2 and 3.

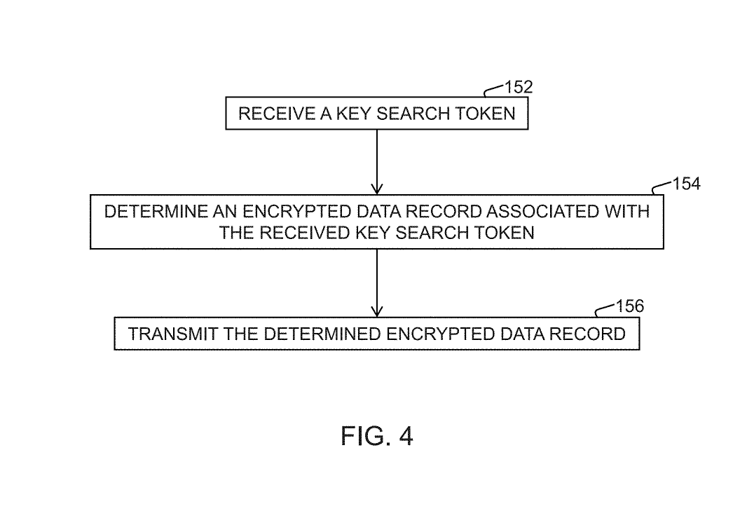

FIG. 4 illustrates a method for performing a search for encrypted data in accordance with an example. In this example, a client 50 submits a key search token to the data storage system 100 so that encrypted data records associated with that particular key search token will be discovered and returned to the client. At 152, the method includes the data storage system 100 receiving a key search token from the client 50. The management unit 130 of the data storage system 100 receives the key search token and also performs the other operations illustrated in FIG. 4.

At 154, the management unit 130 determines one or more encrypted data records associated with the key search token received from the client 50. This operation may be performed by examining table 126 to identify all entries that include that particular key search token. The management unit 130 then uses the IDs associated with that key search token to access table 122 to obtain the encrypted data records associated with the IDs. At 156, the encrypted data record(s) determined from operation 154 is (are) then transmitted back to the client 50 that initiated the search request.

If, by chance, the management unit 130 is unable to locate a data record that comports with the key search token provided by the client, the management unit 130 does not return a data record and may transmit an error message to the client indicative of the problem.

The method of FIG. 4 uses a key search token to retrieve encrypted data records corresponding to that key search token. Alternatively, or additionally, each client 50 may perform a search for encrypted data records based on a plaintext keyword or an encrypted keyword.

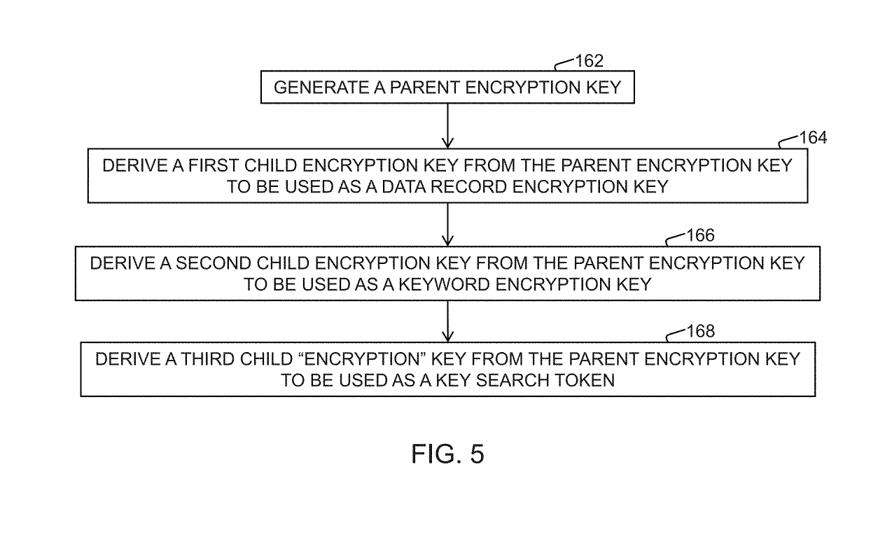

The key search token may be generated in any of a variety of manners. For example, FIG. 5 illustrates one such method which is based on a parent encryption key. At 162, the parent encryption key is caused to be generated by a client 50 as explained above. One or more key derivation functions are caused to be performed by the client 50 to generate a first child encryption key, a second child encryption key and a third child “encryption” key. At 164, the method includes the client 50 causing the first child encryption key to be derived from the parent encryption to be used as a data encryption key, that is, an encryption key to be used to encrypt the data records for storage in, for example, table 122. At 166, the method includes the client 50 causing the second child encryption key to be derived from the parent encryption to be used as a keyword encryption key, that is, an encryption key to be used to encrypt keywords for storage in table 126.

At 168, the method includes the client 50 causing the third child “encryption key” to be derived from the parent encryption to be used as a key search token. The phrase “encryption key is placed in quotes in this context to identify that this search token is derived from a parent encryption key using a key derivation function, but the key search token is not itself used to encrypt anything. As explained above, the key search token has properties (e.g., strong secret and high entropy) sufficient to make it suitable for use as an encryption key, but it is not actually used to encrypt anything (e.g., data records, key words).

One suitable key derivation function that can be used for the method of FIG. 5 is a symmetric cryptographic computation performed on the parent key and a “salt” value. One example of such a computation is a Message Authentication Code (MAC) such as the HMAC-SHA-x, where x={1,224, 256, 384, 512, 3}. A key derived using this function is equal to MAC(K,a), where a is a unique value is the salt value, and K is the parent key from which the derived key is computed. The salt value may be publicly available without compromising security.

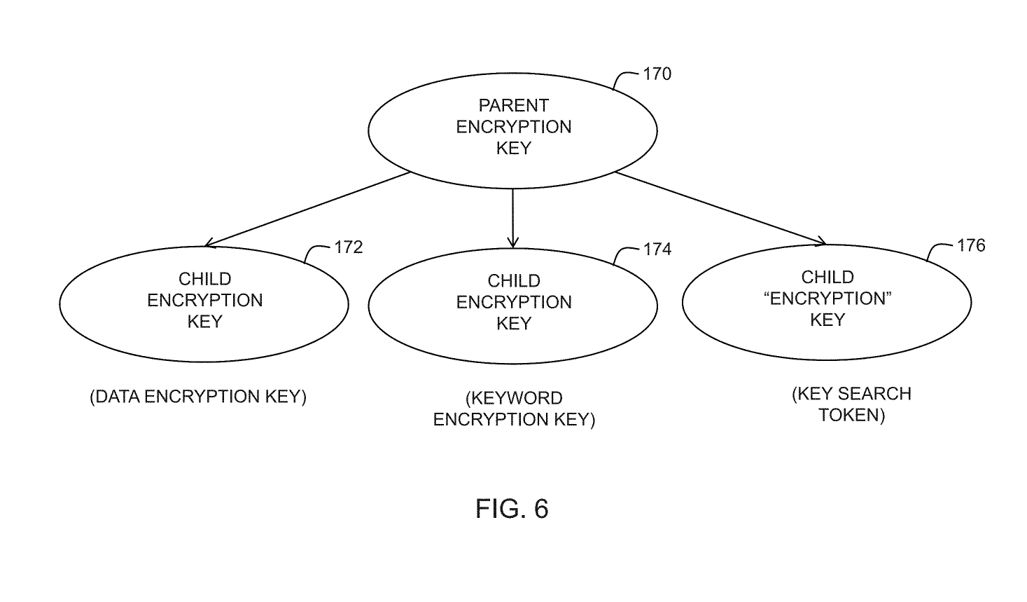

FIG. 6 graphically depicts the method of FIG. 5 in that, from a parent encryption key 170, three (or more) child keys 172, 174, and 176 are derived. Each such child key is used for a different purpose as indicated by the parenthetical insert below each child key 172-176. The child keys 172-176 are mathematically derived from the parent encryption key by using a key derivation function that makes it computationally infeasible to recreate, from a single child key, any of the parent encryption or other child keys, or to infer the parent key from the various child keys.

In another example, the key search token may be chosen as an encryption key that is mathematically independent of the parent encryption key.

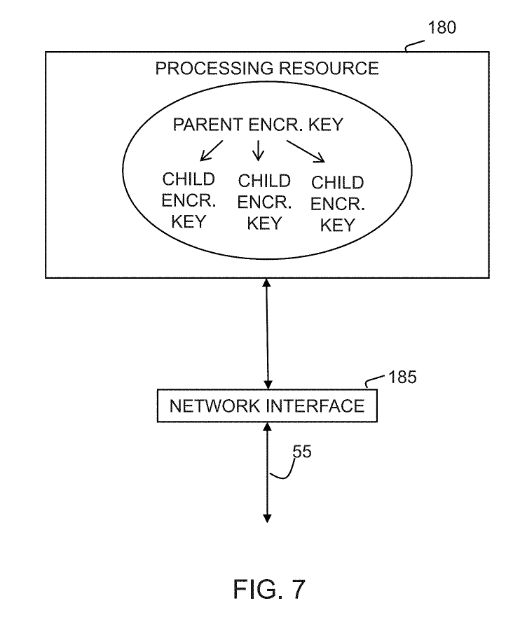

FIG. 7 illustrates an example of block diagram for a client 50. The client 50 may be implemented as a computing apparatus that includes a processing resource 180 coupled to a network interface 185. The processing resource 180 may include a single processor, multiple processors, a single computer or a network of computers. The network interface 185 provides connectivity to the data storage system 100. The processing resource 180 performs the functions described herein as attributable to a client 50. For example, the processing resource 180 may cause a plurality of child encryption keys to be derived from a parent encryption key. As explained above, the child encryption keys may include the first encryption child key (usable to encrypt data records), the second child encryption key (usable to encrypt keywords), and a third child “encryption” key (usable as a key search token). The processing resource 180 may cause the third child “encryption” key (usable as the key search token) to be transmitted through the network interface 185 to the data storage system which contains the encrypted data records. Further, from the data storage system and via the network interface 185, the processing resource 180 may receive an encrypted data record that is associated with the third child “encryption” key. The client may then decrypt the received encrypted data record.

Each client 50 may securely maintain a copy of the information needed to recreate any of the search tokens that enable the searching of encrypted data records. Such information may include a list of all of the client's child keys themselves. Alternatively or additionally, such information may include the parent encryption key along with the salt values. The client 50 may re-compute the child keys based on the parent key and the salt values using the same key derivation functions used previously to encrypt the data records and keywords themselves (first and second child keys, respectively) as well as to generate the key search tokens (third child key). As noted above, the client 50 may interact with the key manager 75 to obtain or recomputed the various child keys using the parent encryption key and salt values.

The encryption process (e.g., to encrypt the data records and/or the keywords) may be an authenticated encryption process. An authenticated encryption process permits a client 50, with knowledge of the authentication key, to determine whether an encrypted data record has been altered since its encryption. An authenticated encryption scheme includes, for example, an “encrypt-then-MAC” technique. In this scenario, an encryption key used for encryption may be replaced with two keys—one for symmetric encryption and the other for the MAC.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
receiving, at a data storage system from a client, a key search token that has not been used to encrypt data records or keywords associated with the data records, said key search token being independent of an encryption key used to encrypt the data records associated with the key search token;
determining, by the data storage system, an encrypted data record associated with the key search token; and
transmitting, by the data storage system, the determined encrypted data record to the client.

2. The method of claim 1 further comprising generating the key search token by:
generating a parent encryption key; and
deriving a child encryption key from the parent encryption key.

3. The method of claim 1 further comprising:
generating a parent encryption key;
deriving a first child encryption key from the parent encryption key to be used as a data encryption key;
deriving a second child encryption key from the parent encryption key to be used as a keyword encryption key; and
deriving a third child encryption key from the parent encryption key to be used as the key search token;

4. The method of claim 1 further comprising generating a data structure to include a plurality of encrypted data records and, associated with each encrypted data record, an encrypted keyword and the key search token.

5. The method of claim 1 further comprising generating a data structure to include a plurality of encrypted data records and, associated with each encrypted data record, an encrypted keyword, a plaintext keyword, and the key search token.

6. The method of claim 1 further comprising generating the key search token by at least one of:
choosing an encryption key that is independent of a parent encryption key; and
performing a symmetric encryption computation on the parent key and a salt value.

7. A data storage system, comprising:
a storage device containing a data structure, the data structure to include a plurality of entries, each entry to include an encrypted data record and, associated with each encrypted data record, an encrypted keyword and a key search token, the key search token not used to encrypt data or a keyword, said key search token being independent of an encryption key used to encrypt the data records associated with the key search token; and
a management unit coupled to the storage device, the management unit to receive a key search token and at least one of a plaintext keyword and an encrypted keyword for encrypted data record retrieval.

8. The data storage system of claim 7 wherein, for at least one entry, the data structure is to include a plurality of keywords associated with a corresponding encrypted data record, at least one such keyword is encrypted.

9. The data storage system of claim 7 wherein, for at least one entry, the data structure is to include a plurality of encrypted keywords associated with a corresponding encrypted data record.

10. The data storage system of claim 7 wherein the management unit is to:
receive a plaintext keyword and search the data structure for an encrypted data record associated with the received plaintext keyword, and upon finding a first encrypted data record associated with the plaintext keyword, provide the first encrypted data record; and
receive an encrypted keyword and search the data structure for an encrypted data record associated with the received encrypted keyword, and upon finding a second encrypted data record associated with the encrypted keyword, provide the second encrypted data record.

11. A computing apparatus, comprising:
a processing resource; and
network interface coupled to the processing resource;
wherein the processing resource causes a plurality of child encryption keys to be derived from a parent encryption key, the child encryption keys to include:
a first child encryption key to be used to encrypt data records to generate encrypted data records;
a second child encryption key to be used to encrypt keywords associated with encrypted data records; and
a third child encryption key to be used as a key search token; and
wherein the processing resource is to cause the third child encryption key to be transmitted through the interface to a data storage apparatus containing encrypted data records and, via the interface, to receive an encrypted data record that is associated with the transmitted third child encryption key.

12. The computing apparatus of claim 11 wherein the processing resource is to cause the third child encryption key to be derived from the parent using a message authentication code (MAC) computation on the parent key and a salt value.

13. The computing apparatus of claim 11 wherein the processing resource is to:
cause a keyword to be encrypted using the second child encryption key;
cause the encrypted keyword to be transmitted through the interface to the data storage apparatus; and
via the interface, to receive an encrypted data record that is associated with the transmitted encrypted keyword.

14. The computing apparatus of claim 11 wherein the computing apparatus is to cause a plurality of child encryption keys to be used as key search tokens and associated with different encrypted data records.

15. The computing apparatus of claim 14 wherein the computing apparatus is to cause a plurality of child encryption keys to be derived from the parent encryption key and used to encrypt a plurality of keywords associated with a common encrypted data record.
